(19) United States
(12) Patent Application Publication
(10) Pub. No.: US 2023/0213841 A1
(43) Pub. Date: Jul. 6, 2023

(54) Device for a body camera to attach to an extendable defense baton

(71) Applicant: Michael Guess, Selma, IN (US)

(72) Inventor: Michael Guess, Selma, IN (US)

(21) Appl. No.: 18/092,172

(22) Filed: Dec. 30, 2022

Related U.S. Application Data
(60) Provisional application No. 63/296,516, filed on Jan. 5, 2022.

(51) Int. Cl. G03B 17/56; G03B 15/03; F16M 13/04

(52) U.S. Cl. CPC G03B 17/561; G03B 15/03; F16M 13/04

(57) ABSTRACT

A device to quickly attach a body camera to an extendable defense baton such as an ASP® friction baton or the like and allow it stream to a cell or other electronic device via a wireless connection. The attachment consists of a backplate having an aperture for an interlocking twist and lock mechanism that inserts into the aperture and interlocks the body camera to the backplate. The backplate in turn has a connection device that secures the backplate to an extendable defense baton. Optional lights with a power source permits a user to enhance building surveillance and/or in operation with checking for contraband or explosives on a vehicle or trailer.

### CROSS-REFERENCE TO RELATED APPLICATIONS

This application claims the benefit of United States Provisional Patent Application with Ser. No. 63/296,516 filed Jan. 5, 2022, by Michael Guess. The application is entitled “A device for a body camera to attach to an extendable defense baton.”

### FIELD OF INVENTION

This invention relates to a device for a body camera to attach to an extendable defense baton. The present invention relates to an extendable supporting device for a body camera, and especially to such a supporting device suitable for use with a body or compact camera. The present invention relates generally to camera supports and methods of using, and more particularly to an assembly to quickly attach to an elongated support, which is preferably a support which connects between an extendable baton and a body camera and can be illuminated to assist clarity of the video. The disclosure relates to an improved connecting device for a body camera including a removable, fast connection device to an extendable baton for law enforcement and rescue personnel to identify danger, contraband, or presence of other people without jeopardizing or putting themselves in harm's way. Examples described herein generally relate to methods, systems, and devices to provide an extendable camera for a mobile device such as a cellphone or electronic tablet. The present application relates generally to camera mounting devices, and, more particularly, to a hand-held mount having quick connections to provide an articulating or extendable arms for better use by law enforcement and rescue personnel.

### FEDERALLY SPONSORED RESEARCH

None.

### SEQUENCE LISTING OR PROGRAM

None.

### BACKGROUND—FIELD OF INVENTION and PRIOR ART

As far as known, there are no devices for a body camera to attach to an extendable defense baton or the like. It is believed that this product is unique in its design and technologies.

### BACKGROUND

This background as to cameras and extension mechanisms should prove useful. Frequently a person with a body or digital camera wants to extend the reach of the camera. A camera with a self-timer function may position the camera on a stationary surface, set the self-timer to take a picture in a few seconds. Similarly, one could use a self-timer and a tripod. However, nothing has suggested using an extension baton such as often carried by law enforcement personnel. While these prior art tripods are suitable for their intended purposed, it is sometimes difficult to use such tripods. Occasionally, a person may hold the camera with an extended arm, but the direction and focus lose the effect one desired. When the camera is held this way, the camera lens angle may not be sufficiently wide to include the desired subject matter for the picture. In about 1984 Minolta introduced the Disc-7 camera, which was sometimes sold as a kit, the kit including an accessory small telescoping arm. The camera included a self-timer, a self-posing convex mirror, and a tiltable handle or grip member mounted on the side of the camera, which handle could also serve as a mini-pod. While this camera and accessory arm permitted self-portraits, it bad many disadvantages.

In addition, if the use of a mirror were desired, the telescoping arm could only be used with the disc-7 camera. Thus, the disc-7 camera was provided with a mirror, whereas the telescoping arm was not. In the regard, it should be noted that it was almost essential to have a mirror on the camera, as the camera was not provided with a view screen as are today's digital cameras. In addition, the user of a camera may want to explore by camera hard-to-reach or unsafe areas. A tripod or extendable “selfie-stick” is not practical.

In an environment with an obstructed viewpoint such as in a crowd at a concert, a political speech, or a graduation ceremony a person attempting to capture an image or audio may have to lift their arms high up to capture such image or audio with a camera/microphone equipped mobile device. Taking pictures/videos/recording audio in this posture poses a number of problems for the person taking the picture/video/audio as well as people around them. For example, it is extremely tedious and uncomfortable to hold one's arm in the air for lengthy periods of time. It is difficult to point and focus the camera/video recorder/audio recorder from this position because the video screen may not be visible. Additionally, a user may block other people's view while holding their arm up in an attempt to capture video in a crowded environment.

Recently, he onset of conventional digital body cameras are capable of recording high definition (HD) video and storing the video locally on a secure digital (SD) card. Conventional body cameras require a significant amount of operator interaction and maintenance to ensure that the body camera is capturing video when needed and further that the captured video is later backed-up. In a law enforcement setting, there is a need for a configurable body camera that can automatically record, maintain, store, and share important environmental and situational data. However, reaching and extending the scope of the body camera has not been taught. Therefore, there is a need to combine the body camera with an extension mechanism. Many law enforcement personnel already carry an extendable baton. An example is the well-known ASP extendable baton. ASP is a registered trademark for such batons offered by Armament Systems and Procedures, Inc. (ASP, Inc.).

### Problem Solved

The improvement and problem solved as to a device for a body camera to attach to an extendable defense baton should be useful. The device: (a) Provides a fast connection for attaching a body camera to an extendable baton; (b) Extends a viewing area for law enforcement or rescue personnel; (c) Provides a safe manner to observe around corners, into basements or attics, into drainage pipes, and under vehicles for surveillance and search for contraband; (d) Can utilize available and existing parts for assembly; (e) Is relatively inexpensive; (f) Is lightweight; (g) Is compact and easily portable; and (h) Keeps law enforcement personnel out of harm's way during surveillance.

### PRIOR ART

As far as known, there are no devices for a body camera to attach to an extendable defense baton and described by Guess. It is believed that this product is unique in its design and technologies. A novelty search revealed:
A. U.S. Pat. No. 4,530,580—by Ueda et al. in 1985 for a Telescopic extender for supporting compact camera. A telescopic extender for supporting a compact camera includes a head member to be attached to the camera, a grip to be held and a telescopic rod member connecting the head member to the grip. A screw member is supported by the head member in a manner that the screw member is rotatable about the axis perpendicular to an extending and collapsing direction of the telescopic rod. The grip can accommodate therein the telescopic rod when the telescopic rod is completely collapsed.
B. U.S. Pat. No. 7,684,694 by Fromm in 2010 for an Apparatus for supporting a camera and method for using the apparatus. A camera support assembly including an elongated support, such as an extensible support, which support extends between a base assembly and a handgrip, whereby a user of the camera may secure a camera to the base assembly and, while holding the handgrip, position the camera a distance away, which may be greater than arm's length, to capture a still or moving image of the user, of an obstructed scene, or of hard to reach and/or unsafe areas.
C. U.S. Pat. No. 9,9112,901 by Thompson in 2018 for a Body Camera. Described herein is a body camera, a method of operating a body camera, a system for a body camera, and methods and systems for configuring a body camera. The body camera may include a digital camera configured to capture video. The body camera may also include one or more sensors for sensing data about the environment experienced by the body camera. The body camera may also include a global positioning system (GPS) receiver. The body camera may also include a transceiver for streaming video and sensor data.
D. 2015/0281525 by Takhur in 2015 for an EXTENDABLE CAMERA. An extendable imager configured to capture an image responsive to a command from a mobile device and an arm coupled to the imager, the arm configured to extend the imager from a surface of the mobile device.
E. 2015/0326764 by Roshanravan in 2015 for an EXTENDABLE-REACH IMAGING APPARATUS WITH MEMORY. Disclosed are embodiments of an image acquisition apparatus with an extendable arm on which an image sensor is located and is easily manipulated to reach hard-to-reach places and transmit captured images to the user. In one embodiment, the combination of a telescopic sensor mount and an image sensor can be an integral part of or an add-on accessory for cell phones, cameras, iPads, iPods, etc. In another embodiment the apparatus may be added to cars or replace car radio antennas, to serve as observation beacons in crowded and congested traffic. In different embodiments the image data gathered by the image sensor may be transmitted to the user by wire, wirelessly, or optically. In other embodiments a microphone and/or a flash may also be installed on the extendable mount. Various embodiments may also include a battery, a processor, a receiver, a transmitter, a data memory/storage, or any combination thereof.
F. WO2015/168472 by Maltese in 2015 for a Hand-held articulating arm camera mount. The present disclosure provides a hand-held camera mount for mounting an imaging device. In one embodiment, a hand-held imaging device mount comprises a handle configured to be held by user; a base connected to the handle; an arm movably secured to the base such that the arm can be rotated relative to the handle and secured in place; and a mount head movably secured to the arm such that the mount head can be moved relative to the arm and secured in place, the mount head configured to mount an imaging device, wherein the imaging device mount permits an imaging device mounted to the mount head to be adjusted with multiple degrees of freedom relive to the handle.
G. D780,248 by Anari, III, et al. in 2017 for an Extending camera support. Claimed the ornamental design for an extending camera support, as shown and described above.

As can be observed, none of the prior art has anticipated or caused one skilled in the art of attachments or devices to be used with extendable batons and a body camera, small camera, or cellphone device to reason, consider, or conclude this invention by Michael Guess as obvious to a person skilled in the ordinary art of the industry. The device for a body camera to attach to an extendable defense baton provides an answer to the problems that are shown above. The Guess invention addresses the shortfalls and solves them, unlike previous art in this industry.

### SUMMARY OF THE INVENTION

This invention is a device for a body camera to attach to an extendable defense baton. A device to quickly attach a body camera to an extendable defense baton such as an ASP® friction baton or the like and allow it stream to a cell or other electronic device via a wireless connection. The attachment consists of a backplate having an aperture for an interlocking twist and lock mechanism that inserts into the aperture and interlocks the body camera to the backplate. The backplate in turn has a connection device that secures the backplate to an extendable defense baton. Optional lights with a power source permit a user to enhance building surveillance and/or in operation with checking for contraband or explosives on a vehicle or trailer. The preferred embodiment of the device for a body camera to attach to an extendable defense baton is comprised of: A device for a body camera to attach to an extendable defense baton that is comprised of: (a) a backplate with a back surface and a front surface, the backplate having an aperture for an interlocking twist and lock mechanism; (b) the twist and lock mechanism of body camera for insertion into the aperture for contiguously interlocking the twist and lock mechanism of body camera to the backplate of body camera; (c) a means to removably connect body camera to the twist and lock mechanism such as a threaded bolt, push-pull rivet, or barb; (d) a means for removably attaching extendable defense baton of backplate on the back surface of device such as a slotted band like radiator clamps, U-bolt with quick clamps fastener with a means to attach means for removably attaching to the extendable defense baton to the backplate such as welding, brazing, adhesive, or other bonding composite material and with a turning wing and threads to engage means for removably attaching extendable defense baton; pair of exterior surfaces of core section; (e) one or more LED, halogen, mercury vapor or incandescent lights having contained power source such as lithium ion or alkaline batteries (rechargeable as an option); and (f) a means to attach lights to backplate on the front surface wherein a user, deputy, officer, military personnel can use the device in operation with a building surveillance and/or in operation with checking for contraband or explosives on a vehicle (car, truck, recreation vehicle, aircraft, train, etc.) or trailer; one or more lights for added lighting for the body camera.

The newly invented device for a body camera to attach to an extendable defense baton can be manufactured at low volumes by quite simple means and in high volume production by more complex and controlled systems.

### OBJECTS AND ADVANTAGES

There are several objects and advantages of the device for a body camera to attach to an extendable defense baton. There are currently no attachment devices, baton features, or connections and the like that are effective at providing the objects of this invention.

A device for a body camera to attach to an extendable defense baton has various advantages and benefits:

| Item | Advantages |
|---|---|
| 1 | Provides a fast connection for attaching a |
| | body camera to an extendable baton |
| 2 | Extends a viewing area for law enforcement |
| | or rescue personnel |
| 3 | Provides a safe manner to observe around |
| | corners, into basements or attics, into |
| | drainage pipes, and under vehicles for |
| | surveillance and search for contraband |
| 4 | Can utilize available and existing parts for |
| | assembly |
| 5 | Is relatively inexpensive |
| 6 | Is lightweight |
| 7 | Is compact and easily portable |
| 8 | Keeps law enforcement personnel out of |
| | harm's way during surveillance |

Finally, other advantages and additional features of the present device for a body camera to attach to an extendable defense baton will be more apparent from the accompanying drawings and from the full description of the device. For one skilled in the art of extendable batons (like ASP® or the like) and devices to couple to the baton, it is readily understood that the features shown in the examples with this product are readily adapted to other types of defense baton-type systems and devices.

### DESCRIPTION OF THE DRAWINGS—FIGURES

The accompanying drawings, which are incorporated in and constitute a part of this specification, illustrate an embodiment of the device for a body camera to attach to an extendable defense baton that is preferred. The drawings together with the summary description given above and a detailed description given below explain the principles of the attachment device for body cameras, small cameras, or cellphones to an extendable defense baton. It is understood, however, that the device for a body camera to attach to an extendable defense baton that is provided here is not limited to only the precise arrangements and instrumentalities shown.

FIGS. 1 A, 1 B, 1 C, and 1 D are sketches showing an overview of the invention and of the general device for a body camera to attach to an extendable defense baton as a front and rear view, a view mounted with a body camera, and an example of use by a deputy or officer on duty.

FIGS. 2 A, 2 B, and 2 C are sketches of the general device for a body camera to attach to an extendable defense baton as a front, side and rear view with components and features noted.

FIGS. 3 A, 3 B, 3 C, 3 D, 3 E, 3 F and 3 G are sketches of the general device for a body camera to attach to an extendable defense baton as a front, side and rear view with the body camera attached and with components and features noted.

FIGS. 4 A and 4 B are sketches of the device for a body camera to attach to an extendable defense baton in operation surveilling around a corner of a building.

FIGS. 5 A, 5 B and 5 C are sketches of the device for a body camera to attach to an extendable defense baton in operation surveilling under a car for contraband or explosive devices.

FIGS. 6 A, 6 B, 6 C, 6 D, 6 E, and 6 F are sketches of the prior art of attachment systems for cameras and the like.

### DESCRIPTION OF THE DRAWINGS—REFERENCE NUMERALS

The following list refers to the drawings:

TABLE B
Reference numbers -

| Ref # | Description |
|---|---|
| 30 | device 30 for a body camera 70 to attach to an |
| | extendable defense baton 60 |
| 34 | backplate 34 of device 30 |
| 34A | back surface 34A of backplate 34 of device 30 |
| 34B | front surface 34A of backplate 34 of device 30 |
| 35 | aperture 35 for interlocking twist and lock |
| | mechanism 71 of body camera 70 |
| 37 | means 37 for removably attaching extendable |
| | defense baton 60 of backplate 34 on the back |
| | surface 34A of device 30 such as a slotted band |
| | like radiator clamps, U-bolt with quick clamps |
| | fastener 38 |
| 38 | means to attach 38 “XX” means for removably |
| | attaching 37 extendable defense baton 60 to |
| | backplate 34 such as welding, brazing, adhesive, |
| | or other bonding composite material |
| 39 | turning wing and threads 39 to engage means 37 |
| | for removably attaching extendable defense baton |
| | 60 |
| 40 | Front View 40 of device 30 |
| 41 | Side View 41 of device 30 |
| 42 | Rear View 42 of device 30 |
| 44 | Front View 44 of device 30 with body camera 70 |
| | attached |
| 45 | Side View 45 of device 30 with body camera 70 |
| | attached |
| 46 | Front View 46 of device 30 with body camera 70 |
| | attached |
| 47 | screen view 47 of body camera 70 on cellphone 72 |
| 48 | Example View 48 of device 30 in operation with a |
| | building 75 surveillance |
| 49 | Example View 49 of device 30 in operation with |
| | checking for contraband or explosives on a |
| | vehicle 76 (car, truck, recreation vehicle, |
| | aircraft, train, etc.) or trailer |
| 50 | one or more lights 50 for added lighting for the |
| | body camera 70, lights having contained power |
| | source such as lithium ion or alkaline batteries |
| | (rechargeable as an option) and the lights being |
| | LED, halogen, mercury vapor or incandescent |
| 51 | means to attach 51 lights 50 to backplate 34 and |
| | front surface 34B such as adhesive, double-sided |
| | tape, hook and loop (like Velcro RTM), small |
| | threaded fasteners, barbed pins etc. |
| 60 | extendable defense baton 60 extendable defense |
| | baton 60 such as a telescoping baton manufactured |
| | by Armament Systems and Procedures, Inc. (ASP, |
| | Inc.). ASP is RTM. |
| 70 | body camera 70 or other device body cameras, |
| | small cameras, or cellphones to attach to the |
| | device 30 |
| 71 | twist and lock mechanism 71 of body camera 70 for |
| | insertion into aperture 35 for contiguously |
| | interlocking twist and lock mechanism 71 of body |
| | camera 70 to backplate 34 |
| 71A | means 71A to removably connect body camera 70 to |
| | twist and lock mechanism 71 such as a threaded |
| | bolt, push-pull rivet, or barb |
| 72 | cellphone 72 |
| 73 | view of screen 73 from cellphone 72 |
| 75 | building 75 |
| 76, 76A | vehicle 76 (car, truck, recreation vehicle, |
| | aircraft, train, etc.) or trailer 76A |
| 77 | elastic band 77 such as a closed loop bungee cord |
| | with end hooks for easy and quick interlocking |
| | the hooks to complete a closure of the loop, a |
| | flat or round thick rubber band, a rubber strip |
| | with a loop and hook closure like a “Velcro” |
| | RTM, or the like |
| 78 | surveilled area 78 |
| 100 | user, deputy, officer, military personnel 100 |
| | using the device 30 |
| 300 | Prior Art 300 International WO2015/168472 issued |
| | to Maltese (2015) - Hand-held articulating arm |
| | camera mount |
| 310 | Prior Art 310 US Patent US Patent Application |
| | filed in 2018 as 2015/0281525 |
| | by Takhur - EXTENDABLE CAMERA |
| 320 | Prior Art 320 US Patent Application filed in 2015 |
| | as 2015/0326764 by Roshanravan - EXTENDABLE-REACH |
| | IMAGING APPARATUS WITH MEMORY |
| 330 | Prior Art 330 U.S. Pat. No. 4,530,580 issued to Ueda |
| | et al. (1985) - Telescopic extender for |
| | supporting compact camera |
| 340 | Prior Art 340 U.S. Pat. No. 7,684,694 issued to Fromm |
| | (2010) - Apparatus for supporting a camera and |
| | method for using the apparatus |
| 350 | Prior Art 350 US Design Patent D780,248 issued to |
| | Anari III, et al. (2017) - Extending camera |
| | support |

### DETAILED DESCRIPTION OF PREFERRED EMBODIMENT

This invention relates to a device for a body camera to attach to an extendable defense baton. The present invention relates to an extendable supporting device for a body camera, and especially to such a supporting device suitable for use with a body or compact camera. The present invention relates generally to camera supports and methods of using, and more particularly to an assembly to quickly attach to an elongated support, which is preferably a support which connects between an extendable baton and a body camera and can be illuminated to assist clarity of the video. The disclosure relates to an improved connecting device for a body camera including a removable, fast connection device to an extendable baton for law enforcement and rescue personnel to identify danger, contraband, or presence of other people without jeopardizing or putting themselves in harm's way. Examples described herein generally relate to methods, systems, and devices to provide an extendable camera for a mobile device such as a cellphone or electronic tablet. The present application relates generally to camera mounting devices, and, more particularly, to a hand-held mount having quick connections to provide an articulating or extendable arms for better use by law enforcement and rescue personnel.

The advantages for the device 30 for a body camera to attach to an extendable defense baton are listed above in the introduction. Succinctly the benefits are that the device:
A. Provides a fast connection for attaching a body camera to an extendable baton;
B. Extends a viewing area for law enforcement or rescue personnel;
C. Provides a safe manner to observe around corners, into basements or attics, into drainage pipes, and under vehicles for surveillance and search for contraband;
D. Can utilize available and existing parts for assembly;
E. Is relatively inexpensive;
F. Is lightweight;
G. Is compact and easily portable; and
H. Keeps law enforcement personnel out of harm's way during surveillance.

The preferred embodiment of the device 30 for a body camera to attach to an extendable defense baton is comprised of: (a) a backplate 34 with a back surface 34A and a front surface 34A, the backplate 34 having an aperture 35 for an interlocking twist and lock mechanism 71; (b) the twist and lock mechanism 71 of body camera 70 for insertion into the aperture 35 for contiguously interlocking the twist and lock mechanism 71 of body camera 70 to the backplate 34 of body camera 70; (c) a means 71A to removably connect body camera 70 to the twist and lock mechanism 71 such as a threaded bolt, push-pull rivet, or barb; (d) a means 37 for removably attaching extendable defense baton 60 of backplate 34 on the back surface 34A of device 30 such as a slotted band like radiator clamps, U-bolt with quick clamps fastener 38 with a means to attach 38 means for removably attaching 37 to the extendable defense baton 60 to the backplate 34 such as welding, brazing, adhesive, or other bonding composite material and with a turning wing and threads 39 to engage means 37 for removably attaching extendable defense baton 60; pair of exterior surfaces 39 of core section 38; (e) one or more LED, halogen, mercury vapor or incandescent lights having contained power source such as lithium ion or alkaline batteries (rechargeable as an option); and (f) a means to attach 51 lights 50 to backplate 34 on the front surface 34B such as adhesive, double-sided tape, hook and loop (Velcro®), small threaded fasteners, barbed pins etc. wherein a user, deputy, officer, military personnel 100 can use the device 30 in operation with a building 75 surveillance and/or in operation with checking for contraband or explosives on a vehicle 76 (car, truck, recreation vehicle, aircraft, train, etc.) or trailer; one or more lights 50 for added lighting for the body camera 70.

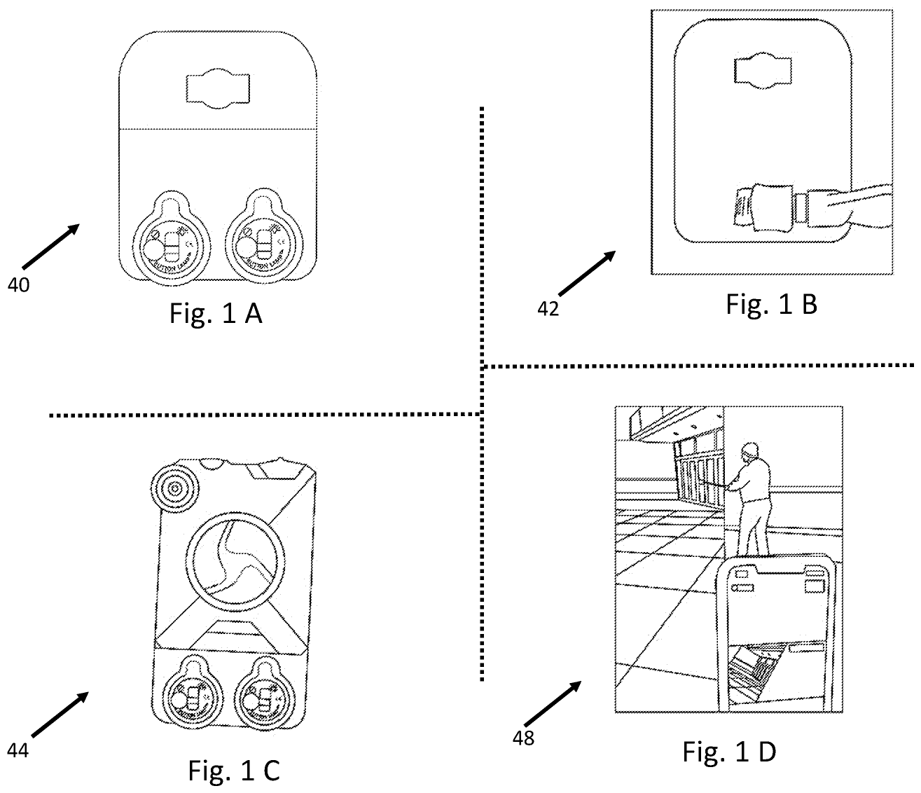

There is shown in FIGS. 1-6 a complete description and operative embodiment of the device 30 for a body camera to attach to an extendable defense baton. In the drawings and illustrations, one notes well that the FIGS. 1-6 demonstrate the general configuration and use of this product. The various example uses are in the operation and use section, below.

The accompanying drawings, which are incorporated in and constitute a part of this specification, illustrate an embodiment of the device 30 for a body camera to attach to an extendable defense baton that is preferred. The drawings together with the summary description given above and a detailed description given below explain the principles of the extendable baton attachment device 30. It is understood, however, that the device 30 is not limited to only the precise arrangements and instrumentalities shown. Other examples of attachment devices and the like are still understood by one skilled in the art to be within the scope and spirit shown here.

1 A, 1 B, 1 C and 1 D are sketches showing an overview of the invention and of the general device 30 for a body camera 70 to attach to an extendable defense baton 60 as a front and rear view, a view mounted with a body camera, and an example of use by a deputy or officer on duty 100. Shown in this overview drawings are: a Front View 40 of device 30; a Rear View 42 of device 30, a Front View 44 of device 30 with body camera 70 attached; and an Example View 48 of device 30 in operation with a building 75 surveillance.

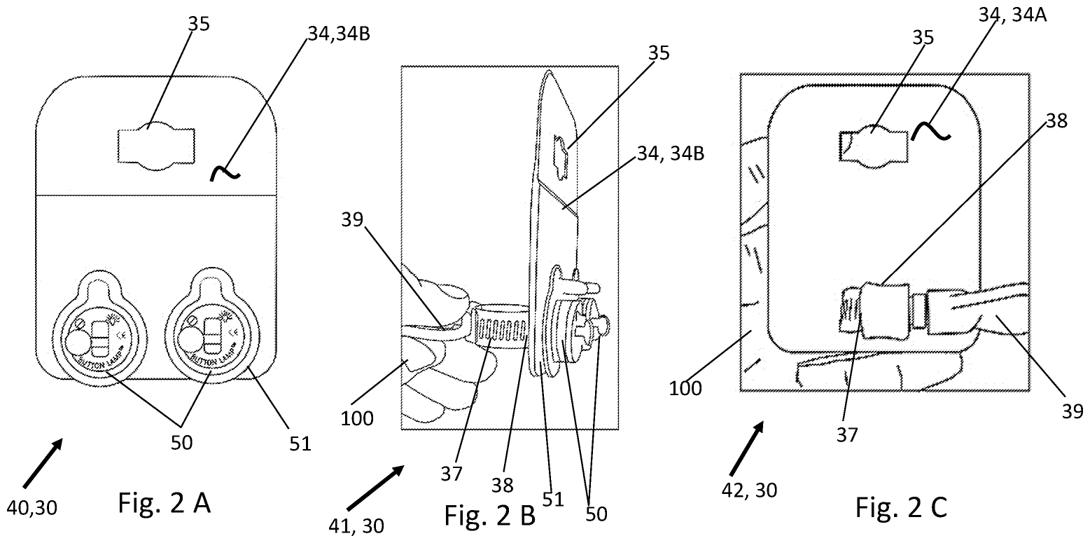

FIGS. 2 A, 2 B, and 2 C are sketches of the general device 30 for a body camera 70 to attach to an extendable defense baton 60 as a front 40, side 41, and rear 42 view with components and features noted. Portrayed in these drawings are: a device 30 for a body camera 70 to attach to an extendable defense baton 60; a backplate 34 of device 30; a back surface 34A of backplate 34 of device 30; a front surface 34A of backplate 34 of device 30; an aperture 35 for interlocking twist and lock mechanism 71 of body camera 70; a means 37 for removably attaching extendable defense baton 60 of backplate 34 on the back surface 34A of device 30 such as a slotted band like radiator clamps, U-bolt with quick clamps fastener 38; a means to attach 38 means for removably attaching 37 extendable defense baton 60 to backplate 34 such as welding, brazing, adhesive, or other bonding composite material; a turning wing and threads 39 to engage means 37 for removably attaching extendable defense baton 60; a Front View 40 of device 30; a Side View 41 of device 30; a Rear View 42 of device 30; one or more lights 50 for added lighting for the body camera 70, lights having contained power source such as lithium ion or alkaline batteries (rechargeable as an option) and the lights 50 being LED, halogen, mercury vapor or incandescent; a means to attach 51 lights 50 to backplate 34 and front surface 34B such as adhesive, double-sided tape, hook and loop (Velcro®), small threaded fasteners, barbed pins etc.; a body camera 70; a twist and lock mechanism 71 of body camera 70 for insertion into aperture 35 for contiguously interlocking twist and lock mechanism 71 of body camera 70 to backplate 34; a cellphone 72; a view of screen 73 from cellphone 72; and a user, deputy, officer, military personnel 100 using the device 30.

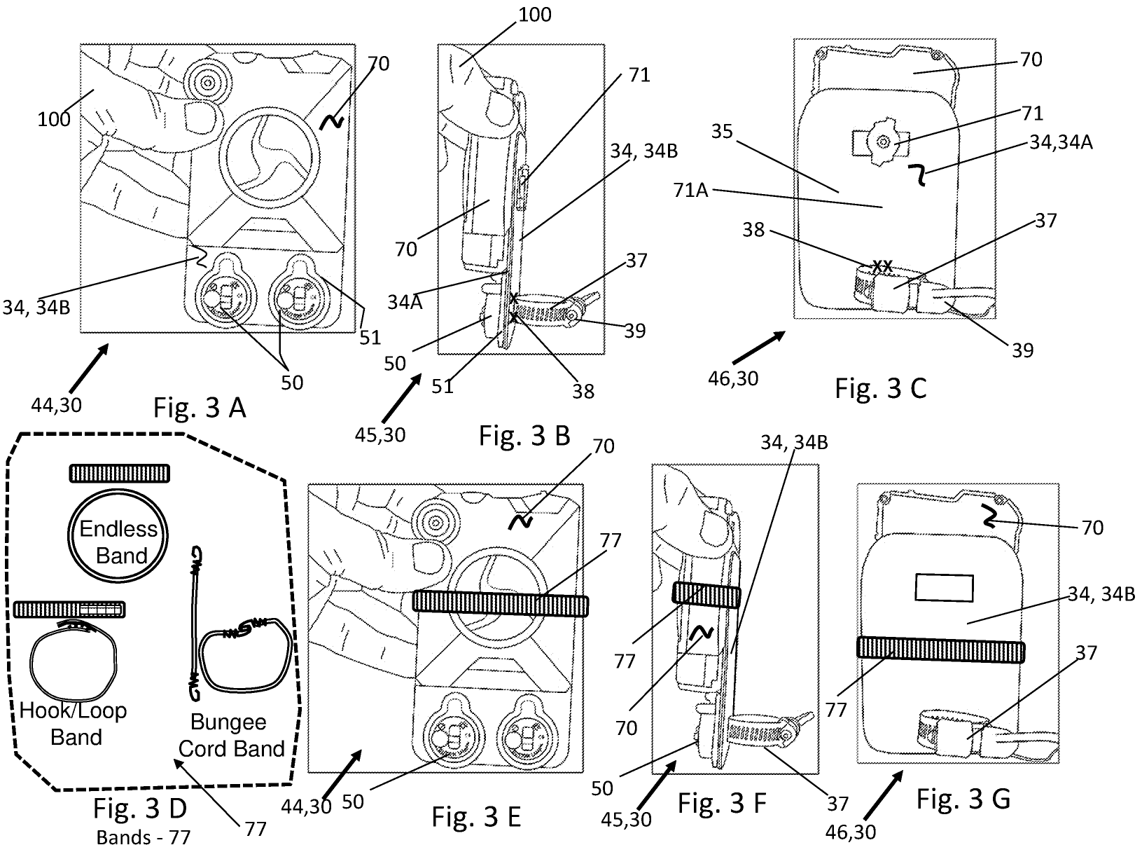

FIGS. 3 A, 3 B, 3 C, 3 D, 3 E, 3 F and 3 G are sketches of the general device 30 for a body camera 70 to attach to an extendable defense baton 60 as a front 44, side 45, and rear 46 view with the body camera 70 attached and with components and features noted. Demonstrated in these drawings are: a device 30 for a body camera 70 to attach to an extendable defense baton 60; a backplate 34 of device 30; a back surface 34A of backplate 34 of device 30; a front surface 34A of backplate 34 of device 30; an aperture 35 for interlocking twist and lock mechanism 71 of body camera 70; a means 37 for removably attaching extendable defense baton 60 of backplate 34 on the back surface 34A of device 30 such as a slotted band like radiator clamps, U-bolt with quick clamps fastener 38; a means to attach 38 the means for removably attaching 37 extendable defense baton 60 to backplate 34 such as welding, brazing, adhesive, or other bonding composite material; a turning wing and threads 39 to engage means 37 for removably attaching extendable defense baton 60; a Front View 44 of device 30 with body camera 70 attached; a Side View 45 of device 30 with body camera 70 attached; a Front View 46 of device 30 with body camera 70 attached; one or more lights 50 for added lighting for the body camera 70, lights having contained power source such as lithium ion or alkaline batteries (rechargeable as an option); a means to attach 51 lights 50 to backplate 34 and front surface 34B such as adhesive, double-sided tape, hook and loop (Velcro®), small threaded fasteners, barbed pins etc.; a body camera 70 or other device body cameras, small cameras, or cellphones to attach to the device 30; a twist and lock mechanism 71 of body camera 70 for insertion into aperture 35 for contiguously interlocking twist and lock mechanism 71 of body camera 70 to backplate 34; a means 71A to removably connect body camera 70 to twist and lock mechanism 71 such as a threaded bolt, push-pull rivet, or barb; and a user, deputy, officer, military personnel 100 using the device 30.

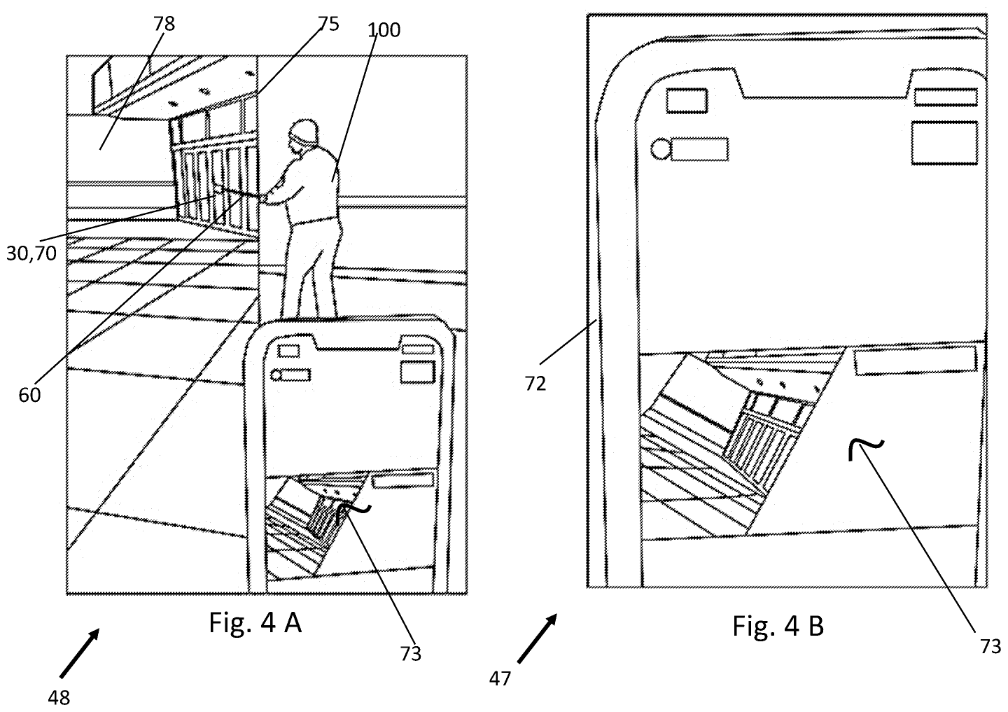

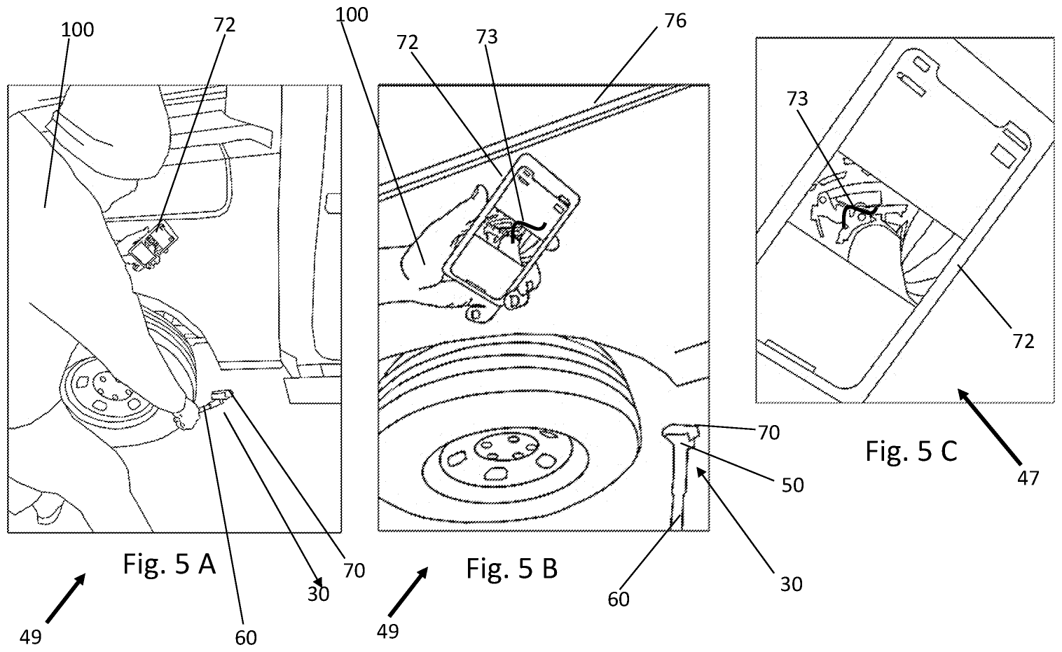

FIGS. 4 A and 4 B are sketches of the device for a body camera to attach to an extendable defense baton in operation surveilling around a corner of a building. And FIGS. 5 A, 5 B and 5 C are sketches of the device for a body camera to attach to an extendable defense baton in operation surveilling under a car for contraband or explosive devices. These are operational views that are discussed below in the Operations Section.

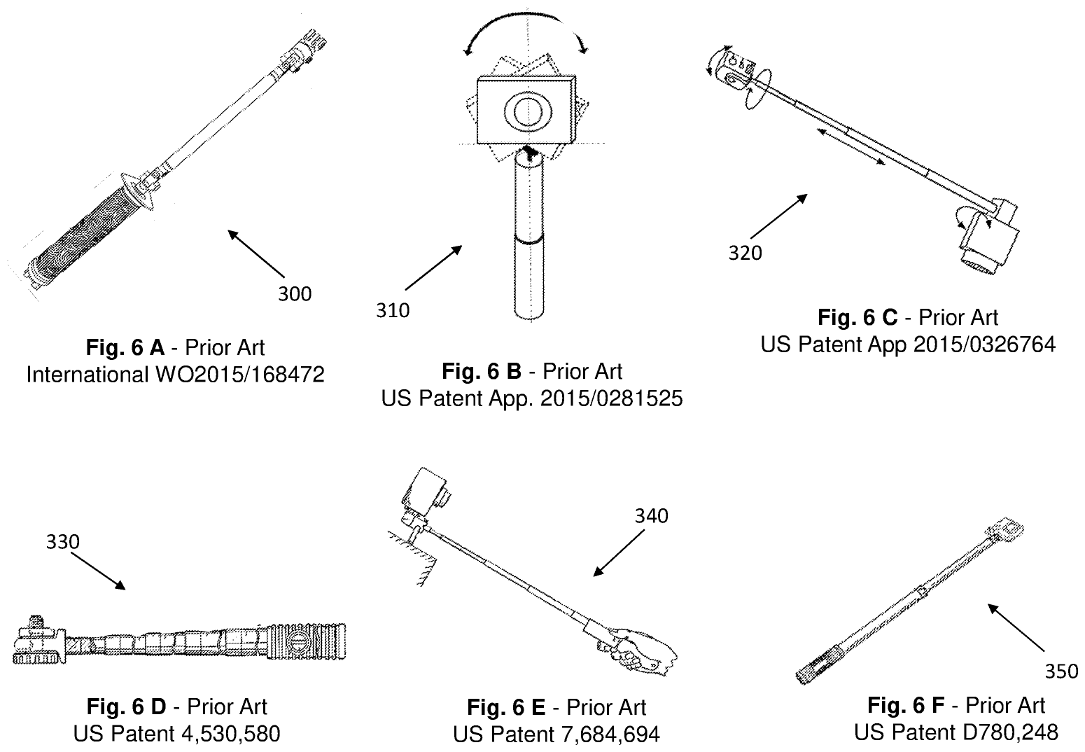

FIGS. 6 A, 6 B, 6 C, 6 D, 6 E and 6 F are sketches of the prior art of attachment systems for cameras and the like are shown. These include: (a) Prior Art 300 International WO2015/168472 issued to Maltese (2015)—Hand-held articulating arm camera mount; (b) Prior Art 310 US Patent US Patent Application filed in 2018 as 2015/0281525 by Takhur—EXTENDABLE CAMERA; (c) Prior Art 320 US Patent Application filed in 2015 as 2015/0326764 by Roshanravan—EXTENDABLE-REACH IMAGING APPARATUS WITH MEMORY; (d) Prior Art 330 U.S. Pat. No. 4,530,580 issued to Ueda et al. (1985)—Telescopic extender for supporting compact camera; (e) Prior Art 340 U.S. Pat. No. 7,684,694 issued to Fromm (2010)—Apparatus for supporting a camera and method for using the apparatus; and (f) Prior Art 350 US Design Patent D780,248 issued to Anari III, et al. (2017)—Extending camera support. As can be seen, the device 30 for a body camera to attach to an extendable defense baton are unique combinations and uses as described herein.

The anticipated materials for the attachment device 30 for extendable batons include: various materials for the backplate 34—metal (steel, stainless steel, bronze, etc.); polymers (nylon, reinforced nylon, ABS, Poly vinyl chloride); and composite materials. For the light 50 LED, halogen, mercury vapor or incandescent, etc. For the contained power source lithium ion or alkaline batteries (rechargeable as an option). As durable and composite materials are developed, it is anticipated they can replace some of the materials shown today.

The details mentioned here are exemplary and not limiting. Other specific components and manners specific to describing a device 30 for a body camera to attach to an extendable defense baton may be added as a person having ordinary skill in the field of attachment systems and devices or baton devices and the like and their uses.

### Operation of the Preferred Embodiment

The device 30 for a body camera to attach to an extendable defense baton has been described in the above embodiment. The manner of how the device operates is described below. One notes well that the description above and the operation described here must be taken together to fully illustrate the concept of the attachment device 30 for extendable defense batons. The preferred embodiment of the device 30 for a body camera 70 to attach to an extendable defense baton 60 that is comprised of: (a) a backplate 34 with a back surface 34A and a front surface 34A, the backplate 34 having an aperture 35 for an interlocking twist and lock mechanism 71; (b) the twist and lock mechanism 71 of body camera 70 for insertion into the aperture 35 for contiguously interlocking the twist and lock mechanism 71 of body camera 70 to the backplate 34 of body camera 70; (c) a means 71A to removably connect body camera 70 to the twist and lock mechanism 71 such as a threaded bolt, push-pull rivet, or barb; (d) a means 37 for removably attaching extendable defense baton 60 of backplate 34 on the back surface 34A of device 30 such as a slotted band like radiator clamps, U-bolt with quick clamps fastener 38 with a means to attach 38 means for removably attaching 37 to the extendable defense baton 60 to the backplate 34 such as welding, brazing, adhesive, or other bonding composite material and with a turning wing and threads 39 to engage means 37 for removably attaching extendable defense baton 60; pair of exterior surfaces 39 of core section 38; (e) one or more LED, halogen, mercury vapor or incandescent lights having contained power source such as lithium ion or alkaline batteries (rechargeable as an option); and (f) a means to attach 51 lights 50 to backplate 34 on the front surface 34B such as adhesive, double-sided tape, hook and loop (Velcro®), small threaded fasteners, barbed pins etc. wherein a user, deputy, officer, military personnel 100 can use the device 30 in operation with a building 75 surveillance and/or in operation with checking for contraband or explosives on a vehicle 76 (car, truck, recreation vehicle, aircraft, train, etc.) or trailer; one or more lights 50 for added lighting for the body camera 70.

The device 30 for a body camera to attach to an extendable defense baton is operated as follows:

### A. Preparation of Device 30:

FIRST attach the twist and lock mechanism 71 of body camera 70 for insertion into aperture 35 for contiguously interlocking twist and lock mechanism 71 to the body camera 70. This is accomplished using a means 71A to removably connect body camera 70 to twist and lock mechanism 71 such as a threaded bolt, push-pull rivet, or barb.

SECOND prepare the backplate 34 of the device 30 (having a back surface 34A, a front surface 34A, and an aperture 35 for interlocking twist and lock mechanism 71 of body camera 70). Attach the means 37 for removably attaching extendable defense baton 60 of backplate 34 on the back surface 34A of device 30 such as a slotted band like radiator clamps, U-bolt with quick clamps fastener 38 by using a means to attach 38 means for removably attaching 37 extendable defense baton 60 to backplate 34 such as welding, brazing, adhesive, or other bonding composite material. Note that the means 37 has a turning wing and threads 39 to engage means 37 for removably attaching extendable defense baton 60.

THIRD attach one or more lights 50 for added lighting for the body camera 70, lights having contained power source such as lithium ion or alkaline batteries (rechargeable as an option) by a means to attach 51 lights 50 to backplate 34 and front surface 34B such as adhesive, double-sided tape, hook and loop (Velcro®), small threaded fasteners, barbed pins etc.
Now the device is ready for use.

### B. Attachment to Body Camera and Baton:

FIRST the device 30 is attached to the body camera 70 by inserting the twist and lock mechanism 71 into the aperture 35 and twisted to interlock.

NEXT the device 30 with the body camera 70 is attached to the extendable defense baton 60 extendable defense baton.

THEN the body camera is connected wirelessly to the cellphone 72 by a Bluetooth or similar connection means.
NOW the device, body camera and baton are secured together and ready for use by the user 100.

### C. Operation/Utilization

User 100 can now use the device 30, body camera 70, baton 60, and cellphone 72 for the mission as an example such as: In operation with a building 75 surveillance or in operation with checking for contraband or explosives on a vehicle 76.
NOTE Additional uses are shown for example and not limitation in the tables below.

FIGS. 4 A and 4 B are sketches of the device 30 for a body camera 70 to attach to an extendable defense baton 70 in operation 48 surveilling around a corner of a building 75. Shown here are: a device 30 for a body camera 70 to attach to an extendable defense baton 60; a screen view 47 of body camera 70 on cellphone 72; an example View 48 of device 30 in operation with a building 75 surveillance; one or more lights 50 for added lighting for the body camera 70, lights having contained power source such as lithium ion or alkaline batteries (rechargeable as an option); an extendable defense baton 60 extendable defense baton 60 such as a telescoping baton manufactured by Armament Systems and Procedures, Inc. (ASP, Inc.)—ASP is ®; a body camera 70 or other device body cameras, small cameras, or cellphones to attach to the device 30; a cellphone 72; a view of screen 73 from cellphone 72; a building 75; a surveilled area 78; and a user, deputy, officer, military personnel 100 using the device 30.

FIGS. 5 A through 5 C are sketches of the device 30 for a body camera 70 to attach to an extendable defense baton 60 in operation 49 surveilling under a car 76 for contraband or explosive devices. Provided in these drawings are: a device 30 for a body camera 70 to attach to an extendable defense baton 60; a screen view 47 of body camera 70 on cellphone 72; an Example View 49 of device 30 in operation with checking for contraband or explosives on a vehicle 76 (car, truck, recreation vehicle, aircraft, train, etc.) or trailer; one or more lights 50 for added lighting for the body camera 70, lights having contained power source such as lithium ion or alkaline batteries (rechargeable as an option); an extendable defense baton 60 extendable defense baton 60 such as a telescoping baton manufactured by Armament Systems and Procedures, Inc. (ASP, Inc.)—ASP is ®; a body camera 70 or other device body cameras, small cameras, or cellphones to attach to the device 30; a cellphone 72; a view of screen 73 from cellphone 72; a vehicle 76 (car, truck, recreation vehicle, aircraft, train, etc.) or trailer 76A; and a user, deputy, officer, military personnel 100 using the device 30.

Many uses are anticipated for the attachment device 30. Some examples, and not limitations, are shown in the following Table.

| Item | Uses |
|---|---|
| 1 | Around corners of buildings for surveillance |
| 2 | Into Attics for surveillance |
| 3 | Into basements or rooms for surveillance |
| 4 | Into sewage or drain tiles/ditches and under |
| | bridges for surveillance |
| 5 | Under vehicles and trailers for checking for |
| | contraband, trap boxes, or explosives |
| 6 | Fire and emergency personnel - for persons |
| | trapped in collapsed buildings |

Many types of devices or mechanisms can benefit from being utilized with the attachment device 30. Some examples, and not limitations, are shown in the following Table.

| Item | Device or Mechanism |
|---|---|
| 1 | Body Camera |
| 2 | Cell Phone |
| 3 | Small, handheld digital cameras |
| 4 | Ends of Optical Fiber connections with photo or |
| | video systems |
| 5 | Fire and rescue - extended cameras on telescoping |
| | pole |

With this description it is to be understood that the device 30 for a body camera to attach to an extendable defense baton is not to be limited to only the disclosed embodiment of product. The features of the device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

The present invention contemplates modifications as would occur to those skilled in the art. While the disclosure has been illustrated and described in detail in the figures and the foregoing description, the same is to be considered as illustrative and not restrictive in character, it being understood that only selected embodiments have been shown and described and that all changes, modifications, and equivalents that come within the spirit of the disclosures described heretofore and or/defined by the following claims are desired to be protected.

What is claimed is:

1. A device (30) for a body camera (70) to attach to an extendable defense baton (60) that is comprised of:
(a) a backplate (34) with a back surface (34A) and a front surface (34A), the backplate (34) having an aperture (35) for an interlocking twist and lock mechanism (71);
(b) the twist and lock mechanism (71) of body camera (70) for insertion into the aperture (35) for contiguously interlocking the twist and lock mechanism (71) of body camera (70) to the backplate (34) of body camera (70);
(c) a means (71A) to removably connect body camera (70) to the twist and lock mechanism (71);
(d) a means (37) for removably attaching extendable defense baton (60) of backplate (34) on the back surface (34A) of device (30) with a means to attach (38) means for removably attaching (37) to the extendable defense baton (60) to the backplate (34) and with a turning wing and threads (39) to engage means (37) for removably attaching extendable defense baton (60);
(e) at least one high intensity light (50) having; and
(f) a means to attach (51) lights (50) to the backplate (34) on the front surface (34B);
wherein a user (100) can use the device (30) in operation with a building (75) surveillance and in operation with checking for contraband and/or explosives on a vehicle (76).

2. The device (30) for a body camera (70) in claim 1 wherein the a means (71A) to removably connect body camera (70) to the twist and lock mechanism (71) is selected from the group consisting of a threaded bolt, a push-pull rivet, and a barb.

3. The device (30) for a body camera (70) in claim 1 wherein the means (37) for removably attaching extendable defense baton (60) of backplate (34) on the back surface (34A) of device (30) is selected from the group consisting of a slotted band radiator clamps and a U-bolt with quick clamps fastener (38).

4. The device (30) for a body camera (70) in claim 1 wherein the means to attach (38) the means for removably attaching (37) the extendable defense baton (60) to the backplate (34) is selected from the group consisting of welding, brazing, adhesive, and a composite material bond.

5. The device (30) for a body camera (70) in claim 1 wherein the at least one high intensity light (50) is selected from the group consisting of a Light Emitting Diode, a halogen lamp, a mercury vapor lamp, and an incandescent bulb.

6. The device (30) for a body camera (70) in claim 1 wherein the contained power source is selected from the group consisting of a lithium-ion and an alkaline battery.

7. The device (30) for a body camera (70) in claim 7 wherein the lithium-ion is rechargeable.

8. The device (30) for a body camera (70) in claim 1 wherein the means to attach (51) lights (50) to the backplate (34) on the front surface (34B) is selected from the group consisting of an adhesive, a double-sided tape, a hook and loop connection, a threaded fasteners, and a barbed pin.

9. The device (30) for a body camera (70) in claim 1 wherein the user is selected from the group consisting of a deputy, a police officer, and a military personnel.

10. The device (30) for a body camera (70) in claim 1 wherein the vehicle (76) is selected from the group consisting of a car, a truck, a recreation vehicle, an aircraft, and a train.

11. The device (30) for a body camera (70) in claim 1 is further comprised with an elastic band (77).

12. The device (30) for a body camera (70) in claim 11 wherein the elastic band (77) is selected from the group consisting of a closed loop bungee cord with end hooks for easy and quick interlocking the hooks to complete a closure of the loop, a flat or round thick rubber band, and a rubber strip with a loop and hook closure.

13. A device (30) for a body camera (70) to attach to an extendable defense baton (60) that is comprised of:
(a) a backplate (34) with a back surface (34A) and a front surface (34A), the backplate (34) having an aperture (35) for an interlocking twist and lock mechanism (71);
(b) the twist and lock mechanism (71) of body camera (70) for insertion into the aperture (35) for contiguously interlocking the twist and lock mechanism (71) of body camera (70) to the backplate (34) of body camera (70);
(c) a threaded fastener to removably connect body camera (70) to the twist and lock mechanism (71);
(d) a radiator clamp as a means (37) for removably attaching extendable defense baton (60) of backplate (34) on the back surface (34A) of device (30) the radiator clamp brazed to the backplate (34) and the radiator clamp having a turning wing and threads (39) for removably attaching extendable defense baton (60);
(e) at least one high intensity Light emitting diode (LED) (50) with a contained lithium-ion battery as a power source; and
(f) an adhesive to attach the LED light to the backplate (34) on the front surface (34B)
wherein a user (100) can operate the device (30) in a building (75) surveillance and in checking for contraband or explosives on a vehicle (76).

14. The device (30) for a body camera (70) in claim 13 is further comprised with an elastic band (77).

15. The device (30) for a body camera (70) in claim 14 wherein the elastic band (77) is selected from the group consisting of a closed loop bungee cord with end hooks for easy and quick interlocking the hooks to complete a closure of the loop, a flat or round thick rubber band, and a rubber strip with a loop and hook closure.
